(19) United States
(12) Patent Application Publication
(10) Pub. No.: US 2007/0076529 A1
(43) Pub. Date: Apr. 5, 2007

(54) Wrist swim lap counter

(76) Inventor: Feng Lin, Singapore (SG)

Correspondence Address: FENG LIN, Blk 110, #12-120, Woodlands Street 13, Singapore, 730110, SG

(21) Appl. No.: 11/324,694

(22) Filed: Jan. 4, 2006

(30) Foreign Application Priority Data
Oct. 1, 2005 (SG) D2005/1676/H

(51) Int. Cl. G04F 8/00; G04F 10/00

(52) U.S. Cl. 368/107

(57) ABSTRACT

The invention provides a cheap mechanical wrist swim lap counter for counting the number of laps traversed by a swimmer in a swimming pool. The lap counter consists of a front and a rear covers, a finger gear wheel and a pad. The lap counter uses the friction force between surfaces of gear wheel and covers to prevent gear wheel from rotating in swimming, and to provide a consistent feeling when the swimmer dials the gear wheel. The invention also provides a design to prevent lap counter from flipping in swimming.

### CROSS-REFERENCE TO RELATED APPLICATION

This application claims priority of Singapore (SG) design application No. D2005/1676/H filed Oct. 1, 2005.

### FIELD OF THE INVENTION

The present invention relates to a mechanical wrist counter for counting the number of laps traversed by a swimmer in a swimming pool.

### BACKGROUND OF THE INVENTION

A swimmer wants to know the distance he travels in a swimming pool having a specified length in lanes. Each length of the pool traversed is referred to as a lap. The swimmer can determine the total distance traveled by counting the number of laps he has traversed and multiplying this figure by the lane length.

Currently, to count laps, some swimmers use electrical sports watches, which are relative expensive, consume batteries, and have the possibility of water leak. But most swimmers just count and memory laps in the brains. However they feel that it is hard to count and remember laps when exhausted; it is not possible to have relax exercises or focuses on other objects, as keep memorizing laps; or they are often puzzled about how many laps they really have done after their swimming.

### BRIEF SUMMARY OF THE INVENTION

The first object is to provide cheap wrist lap counters for swimmers. And the second object is to provide a design to prevent wrist lap counters from flipping in swimming.

A lap counter for a swimmer to wear on wrist to count laps in swimming, comprising (1) a finger gear wheel with numbers printed in a circle around the center on the front surface, each number relating to a gear; (2) a front cover with a gap and a window; (3) a rear cover with a gap; and (4) a wedge pad under the rear cover.

Two or four eyelets fasten the front and the rear covers together. The gear wheel is fixed on a bent axis to and between the covers. The gear wheel and the front cover are made from soft plastic. The eyelets and the bent axis exert pressure to let the soft plastic surfaces of the gear wheel fully touch surfaces of the front and the rear covers to generate reliable and steady friction force to prevent the gear wheel from rotating in swimming, and to provide the swimmer a consistent feeling each time he dials the gear wheel;

The wheel is hidden between the covers, but the gap of the front cover uncovers a gear of the wheel, and the number relating to the uncovered gear shows in the window of the front cover. When the swimmer dials the uncovered gear to the edge of the gap, the wheel rotates a gear, thus the uncovered gear moves inside the covers, but another gear moves out to become a new uncovered gear, and the number relating to the new uncovered gear shows in the window.

A cord ties the lap counter to wrist. On wrist, the thin end of the wedge pad lowers the left side of the lap counter, thus reduces water force and gives more force for the cord to pull back the lap counter whenever water flips it. As well as the thick end of the wedge pad lifts the right side, thus prevents the uncovered gear to jab wrist.

For the lap counter fastened by four eyelets, the cord ties the four eyelets to wrist with two parallel cord portions around wrist.

### BRIEF DESCRIPTION OF THE DRAWINGS

FIG. 1 is a perspective view of the first embodiment of the wrist swim lap counter of the invention;

FIG. 2 is a side view of first embodiment being worn on wrist;

FIG. 3 is an exploded perspective view of the first embodiment;

FIG. 4 is a front view of a finger gear wheel of the invention;

FIG. 5 is a cross sectional view of A-A;

FIG. 6 is a rear view of the first embodiment;

FIG. 7 is a perspective view of an alternative pad of the first embodiment;

FIG. 8 is a perspective view of the second embodiment of the wrist swim lap counter of the invention;

FIG. 9 is a rear view of the second embodiment;

FIG. 10 is a perspective view of a pad of the second embodiment;

FIG. 11 is a front view of the third embodiment of the invention;

FIG. 12 is a rear view of the third embodiment;

FIG. 13 is a right side view of the third embodiment;

FIG. 14 is a front view of the fourth embodiment of the wrist swim lap counter of the invention;

FIG. 15 is a rear view of the fourth embodiment;

FIG. 16 is a right side view of the fourth embodiment;

FIG. 17 is a bottom view of the fourth embodiment;

FIG. 18 is a bottom view of the fourth embodiment being worn on wrist;

FIG. 19 is a front view of the fifth embodiment of the wrist swim lap counter of the invention;

FIG. 20 is a rear view of the fifth embodiment;

FIG. 21 is a right side view of the fifth embodiment;

FIG. 22 is a front view of the finger gear wheel of the fifth embodiment;

FIG. 23 is a front view of the fifth embodiment showing number 1;

FIG. 24 is a front view of the sixth embodiment of the invention;

FIG. 25 is a rear view of the sixth embodiment;

FIG. 26 is a right side view of the sixth embodiment;

FIG. 27 is a front view of the finger gear wheel of the sixth embodiment;

FIG. 28 is a rear view of the finger gear wheel of the sixth embodiment;

FIG. 29 is an exploded perspective view of the sixth embodiment; and

FIG. 30 is a front view of the sixth embodiment showing number 1.

### DETAILED DESCRIPTION OF THE INVENTION

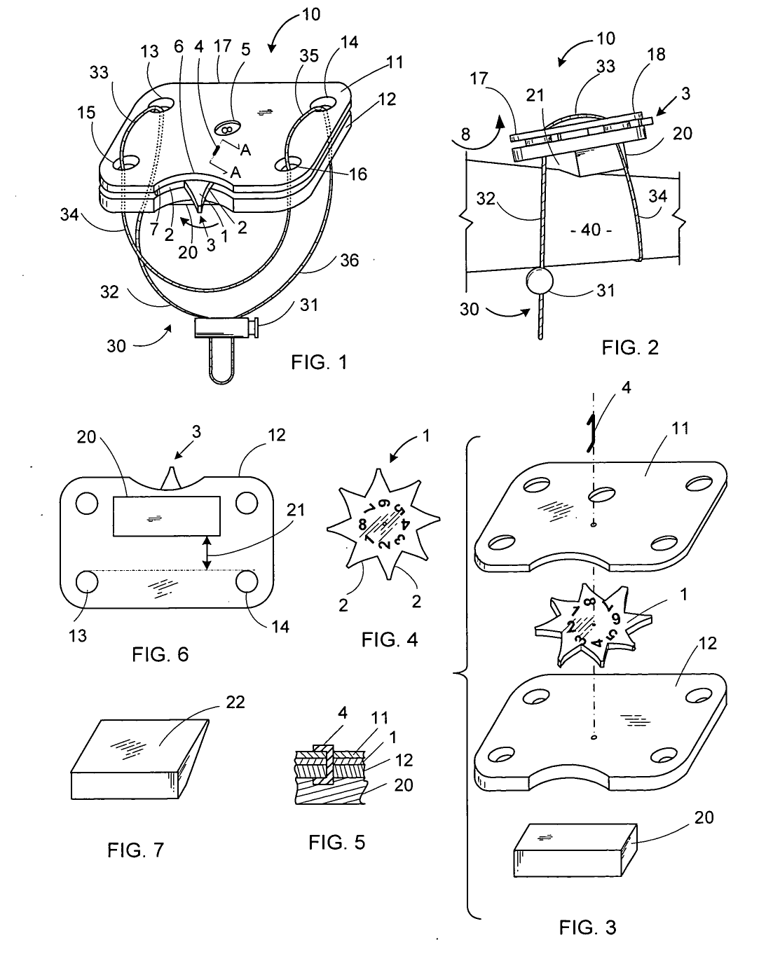

Referring now to the drawings, FIGS. 1-7 illustrate the first embodiment, which is a wrist swim lap counter 10. Swim lap counter 10 consists of (1) a finger gear wheel 1, with an axis 4; (2) a front cover 11 with four eyelets 13-16; (3) a rear cover 12; (4) a pad 20; and (5) a cord 30 with a cord lock 31.

Refer to FIG. 4. Finger gear wheel 1 has eight gears. Numbers 1-8 are printed equally in a circle around the center on the front surface. Each number relates to a gear.

Refer to FIGS. 1 and 3. Wheel 1 is placed between a front cover 11 and a rear cover 12. Wheel 1 and covers 11 are made from flat soft plastic sheet by die cutting. The thickness of wheel 1 and covers 11-12 is about 0.4 mm, 0.5 mm and 1 mm respectively. When they are placed together to form lap counter 10, the height is less than 2 mm, and the weight is less than 5 gram. Front cover 11 and rear cover 12 have same outline and shape of near rectangle about 5 cm×3 cm. Front cover 11 is visible by a swimmer in swimming. An advantage of the wrist swim lap counter of the invention is that material cost of plastic sheet and cord is low, thus a swimmer can have it at a low price such as less than one dollar. Other advantages are battery free, waterproof, and very simple operation.

Refer to FIGS. 1 and 5. Covers 11-12 are fastened together by four eyelets 13-16. Wheel 1 is fixed to covers 11-12 by a bent axis 4. Wheel 1 can rotate around axis 4. Wheel 1 is placed between covers 11-12, thus its front surface touches the surface of covers 11, and its rear surface touches the surface of cover 12. Four eyelets 13-16 and bent axis 4 exert pressure to let these surfaces touch. As wheel 1 and cover 11 are soft plastic, so these surfaces fully touch each other under the pressure. The fully touched soft plastic surfaces will generate reliable and steady friction force when wheel 1 rotates. Further, wheel 1 is so thin about 0.4 mm that it restricts swimming water to generate strong force onto wheel. Thus, the friction force resists wheel 1 from randomly rotating when a swimmer strikes and beats lap counter 10 in the water in swimming. In order to rotate wheel 1, a swimmer needs to use finger's force to overcome this friction. As this friction force is reliable and steady, so the swimmer has a consistent feeling each time he rotates the wheel.

Refer to FIG. 1. Front cover 11 has a window or a hole 5, which is so small as to just show one of numbers 1-8 of wheel 1. Covers 11-12 hides wheel 1, but they have a gap 6, which uncovers one gear of wheel 1. Uncovered gear 3 can be touched and dialed by a swimmer, and the number that relates to uncovered gear 3 shows in window 5.

When a swimmer wants to count one more lap after he travels a lap, he dials uncovered gear 3 to edge 7 of gap 6. Thus, wheel 1 rotates a gear, current uncovered gear 3 moves inside covers 11-12, but another gear moves out from covers 11-12 to become a new uncovered gear 3, and the number (i.e. next lap number) relating to the new uncovered gear 3 shows in window 5.

A finger can touch any portion of edge 2 of gear 3 to rotate wheel 1. To ensure exactly move one gear for a dial, edge 2 is designed to have same curve as edge 7 (the portion that stop the finger) of gap 6. So as long as edge 7 stops a finger, even if the finger may dial at the different portion of edge 2, wheel 1 rotates exact same amount of 360/8=45 degree, and the number relating to new uncovered gear 3 shows entirely in window 5.

Refer to FIGS. 2 and 6. A soft rubber or plastic pad 20 is placed under rear cover 12. When a swimmer wears lap counter 10, pad 20 lifts it on wrist 40, so his finger can dial gear 3.

Refer to FIG. 2. In swimming, especially freestyle, water force 8 is strong enough to flip lap counter 10 and drive gear 3 to jab wrist 40.

Refer to FIGS. 1-2. Pad 20, four eyelets 13-16, cord 30 and cord lock 31 are designed to work together to overcome flipping. Cord 30 goes through eyelets 13-16 to tie lap counter 10 to wrist 40. Cord 30 starts from cord lock 31, cord portion 32 goes around wrist 40 to eyelet 13, portion 33 goes to eyelet 15, portion 34 goes around wrist 40 to eyelet 16, portion 35 to eyelet 14, and finally portion 36 goes around wrist 40 back to cord lock 31.

When a swimmer wants to wear lap counter 10 to wrist 40, he holds cord lock 41 and pulls, cord portion 34 is tied to wrist 40 first; and then he opens cord lock 31 and moves it to near wrist 40 to tie cord portion 32/36. Now lap counter 10 is tied firmly at four corners by two parallel cord portions 34 and 32/36 onto wrist 50.

Refer to FIGS. 1-2 and 6. Pad 20 ends before eyelets 13-14, so there is a space 21 between pad 20 and cord portion 32/36. When cord 30 is tied tightly, due to space 21, lap counter 10 inclines to form a lowered left side 17 and a heightened right side 18. Lowered left side 17 reduces water force 8 that flips lap counter 10, and lets cord portion 32/36 generate more force to pull back lap counter 10 whenever water flips it. As well as heighten right side 18 prevents gear 3 to jab wrist 40, and lets a swimmer to dial gear 3 easily.

It is possible to use a wedge pad 22 instead of pad 20. Wedge pad 22 is comfortable on wrist, as its whole surface touches wrist. When wedge pad 22 is placed under rear cover 12, lap counter 10 also inclines to have advantages described above.

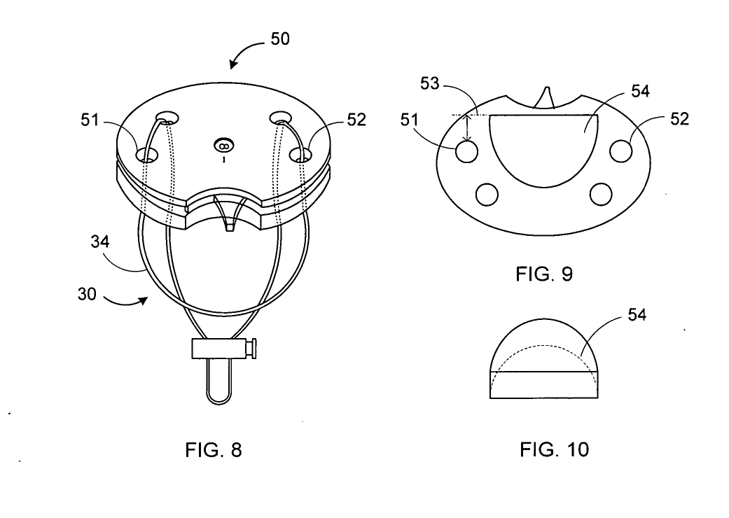

Referring now to the drawings, FIGS. 8-10 illustrate the second embodiment of the invention, which is swim lap counter 50. The differences between the first and the second embodiments are that lap counter 50 has an oval shape, uses a semi-circle pad 54, and has eyelet 51-52 away from front end 53 of pad 54, which lets cord portion 34 also generate force to pull back lap counter 50 whenever water flips it around end 53. Except the differences, the second embodiment has the same structure and operation principle as the first embodiment. Refer to the description of the first embodiment for understanding the second embodiment.

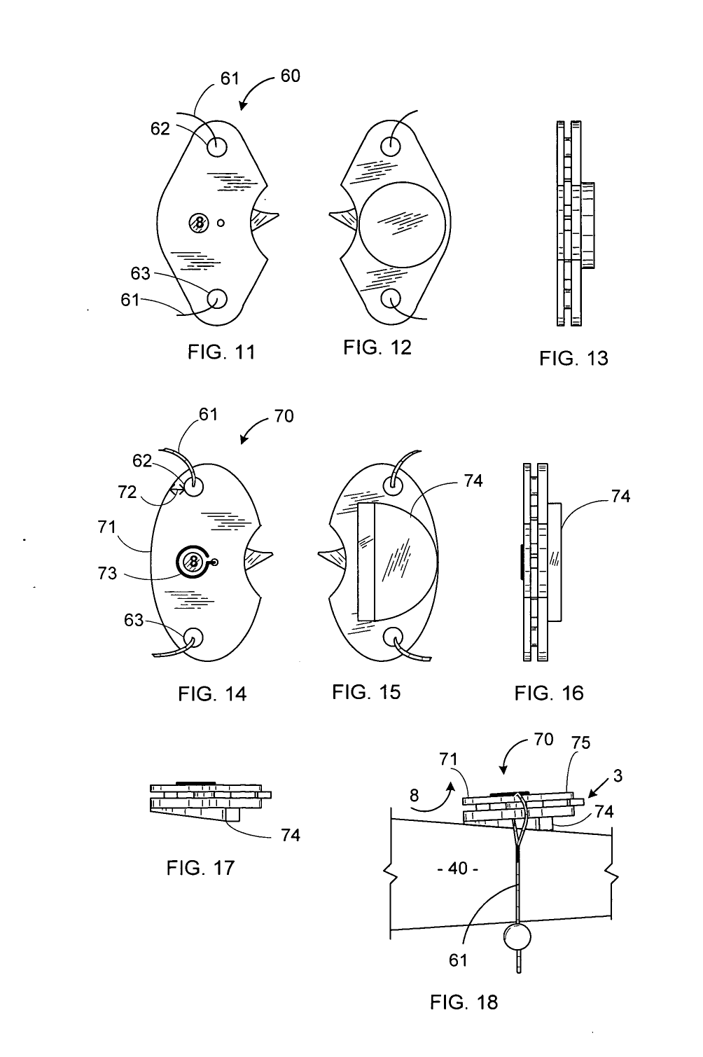

Referring now to the drawings, FIGS. 11-13 illustrate a third embodiment, which is wrist lap counter 60. Lap counter 60 has the same internal structure and operation principle as the first embodiment. However it is designed to have an oval or olive shape, and use two eyelets 62-63 to fasten covers. A cord 61 simply ties to eyelets 62-63 for user to wear on wrist.

Referring now to the drawings, FIGS. 14-18 illustrate the fourth embodiment, which is swim lap counter 70. Lap counter 60 of the third embodiment tends to flip in swimming. Comparing with lap counter 60, lap counter 70 uses a circle bent axis 73 to generate pressure, has two eyelets 62-63 and cord 61 left shifted 72, and uses a wedge pad 74. Lowered left side 71 reduces water force 8, and lifted right side 75 prevents gear 3 to jab wrist 40. Further left shifted cord 61 and lowered left side 71 let cord 61 to generate more force to pull back lap counter 70 whenever water flips it around right side 75.

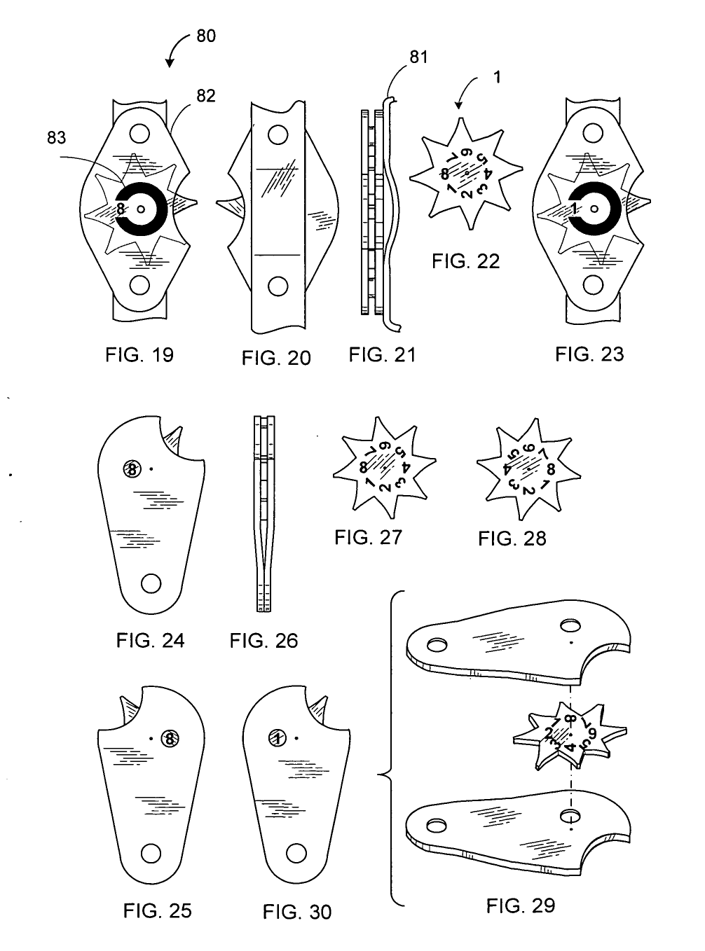

Referring now to the drawings, FIGS. 19-23 illustrate the fifth embodiment, which is swim lap counter 80. Comparing with lap counter 60, lap counter 80 is fastened on a wristband, and has a transparent front cover 82. As numbers 1-8 of wheel 1 is visible through transparent cover 82, so an opaque FIG. 83 is printed on cover 82, which just allows one of numbers 1-8 is visible through cover 82.

Referring now to the drawings, FIGS. 24-30 illustrate the sixth embodiment, which is a hand lap counter. The lap counter is held in hand, and the lap number is visible on both sides. A bent axis exerts pressure between surfaces of wheel and covers to generate friction.

It is clear that lap counters of the invention can also be used to count small number for other purposes such as counting laps for runners and cyclists, and counting strokes for golfers. It is clear that finger gear wheel can have other number of gears; the wheel, the covers and the pad can have other shapes; window 5 can be at different location on front cover; and rear cover and pad can integrate to form a component.

I claim:

1. A lap counter for a swimmer to wear on wrist to count laps in swimming, comprising:
a front cover having a gap and a window;
a rear cover fastened to the front cover;
a gear wheel having numbers printed in a circle around the center on the front surface, with each number relating to a gear, wherein the gear edge of the gear wheel has the same curve as the edge of the gap of the front cover;
an axis fixing the gear wheel to and between the front cover and the rear cover;
a uncovered gear being a gear of the gear wheel uncovered by the gap of the front cover, with the number relating to the uncovered gear showing in the window of the front cover, wherein when the swimmer's finger dials the uncovered gear to the edge of the gap, the gear wheel rotates a gear, and the uncovered gear moves inside the front and the rear covers, but another gear of the gear wheel moves out to become a new uncovered gear in the gap, and the number relating to the new uncovered gear shows in the window;
wherein the gear wheel and the front cover are made from soft plastic;
means for exerting pressure to let the soft plastic surfaces of the gear wheel fully touch surfaces of the front cover and the rear cover to generate reliable and steady friction force to prevent the gear wheel from rotating in swimming, and to provide the swimmer a consistent feeling each time the swimmer dials the uncovered gear; and
a pad under the rear cover lifting the lap counter for the swimmer to dial the uncovered gear.

2. A lap counter according to claim 1, further comprising eyelets fastening the front cover and the rear cover together, and wherein the means for exerting pressure comprises using the eyelets, and/or using the axis bent to press the front cover and the rear cover.

3. A lap counter according to claim 2, further comprising a cord tying the lap counter through eyelets to wrist.

4. A lap counter according to claim 3, wherein the pad has a wedge shape so that when the lap counter is worn on wrist, the thin end of the wedge pad lowers the left side of the lap counter, thus reduces water force and generates more force for the cord to pull back the lap counter whenever water flips it, as well as the thick end of the wedge pad lifts the right side of the lap counter, thus prevents the uncovered gear to jab wrist.

5. A lap counter according to claim 3, wherein there is a space between the end of the pad and the cord so that when the lap counter is worn on wrist and the cord is tied, the lap counter inclines to form a lowered left side and a heighten right, thus the lowered left side reduces water force and generates more force for the cord to pull back the lap counter whenever water flips it, as well as the heighten right side prevents the uncovered gear to jab wrist.

6. A lap counter according to claim 3, wherein there are four eyelets, when the lap counter is worn on wrist, the cord ties the four eyelets to wrist with two parallel cord portions around wrist, each of which tied to two eyelets.

7. A lap counter according to claim 2, further comprising a wristband on which two eyelets fasten the lap counter.

8. A counter for a user to count number, comprising
a front cover having a gap and a window; a rear cover;
a gear wheel having numbers printed in a circle around the center on the front surface, with each number relating to a gear, wherein the gear edge of the gear wheel has the same curve as the edge of the gap of the front cover;
one or two eyelets fastening the front cover and the rear cover together;
a bent axis fixing the gear wheel to and between the front cover and the rear cover;
a uncovered gear being a gear of the gear wheel uncovered by the gap of the front cover, with the number relating to the uncovered gear showing in the window of the front cover, wherein when the user's finger dials the uncovered gear to the edge of the gap, the gear wheel rotates a gear, and the uncovered gear moves inside the front and the rear covers, but another gear of the gear wheel moves out to become a new uncovered gear in the gap, and the number relating to the new uncovered gear shows in the window;
wherein the gear wheel and the front cover are made from soft plastic; and
wherein the eyelets and/or the bent axis exert pressure to let the soft plastic surfaces of the gear wheel fully touch surfaces of the front cover and the rear cover to generate reliable and steady friction force to prevent the gear wheel from rotating randomly, and to provide the user a consistent feeling each time the user dials the uncovered gear.

9. A counter according to claim 8, further comprising a wristband on which two eyelets fasten the counter.

10. A counter according to claim 8, further comprising
a wedge pad under the rear cover lifting the right side of the counter on wrist for the user to dial the uncovered gear easily; and
a cord tying the counter through two eyelets to wrist of the user.
